(19) United States
(12) Patent Application Publication
(10) Pub. No.: US 2019/0323113 A1
(43) Pub. Date: Oct. 24, 2019

(54) METHOD FOR THE MANUFACTURE OF A COATING HAVING A COLUMNAR STRUCTURE

(71) Applicant: OERLIKON METCO AG, WOHLEN, Wohlen (CH)

(72) Inventors: Rajiv J. DAMANI, Winterthur (CH); Arno REFKE, Fahrwangen (CH)

(73) Assignee: OERLIKON METCO AG, WOHLEN, Wohlen (CH)

(21) Appl. No.: 16/459,027

(22) Filed: Jul. 1, 2019

Related U.S. Application Data
(63) Continuation of application No. 14/873,790, filed on Oct. 2, 2015, now abandoned.
Application No. 14/873,790 is a continuation of application No. 11/905,500, filed on Oct. 1, 2007, now abandoned.

(30) Foreign Application Priority Data
Oct. 2, 2006 (EP) 06121637.0
May 3, 2007 (EP) 07107447.0

(51) Int. Cl. C23C 4/134; C23C 4/123; C23C 4/12; C23C 4/11

(52) U.S. Cl. CPC C23C 4/134; C23C 4/123; Y02T 50/67; C23C 4/11; C23C 4/12

(57) ABSTRACT

Method for the manufacture of a coating having a columnar structure, preferably a dense structure, in which method a coating material in the form of primary corpuscles is injected with a carrier gas into a thermal process beam. The coating material is transferred into a vapor phase in the process beam and is deposited as a condensate in the form of a columnar coating on a substrate. The primary corpuscles are formed by an agglomerate of particles which are held together by cohesive forces of a connecting medium or by adhesive forces.

### CROSS-REFERENCE TO RELATED APPLICATIONS

The present application is a continuation of U.S. application Ser. No. 14/873,790 filed Oct. 2, 2015, which is a continuation of U.S. application Ser. No. 11/905,500 filed Oct. 1, 2007, which claims priority under 35 U.S.C. § 119(a) of European Patent Application No. 06 121 637.0 filed Oct. 2, 2006 and of European Patent Application No. 07 107 447.0 filed May 3, 2007. The disclosures of U.S. application Ser. Nos. 11/905,500 and 14/873,790, and all documents expressly incorporated by the same, is expressly incorporated by reference herein in its entirety.

### BACKGROUND OF THE INVENTION

### 1. Field of the Invention

The invention relates to a method for the manufacture of a coating having a columnar structure as well as to a spray powder with which the method can be carried out.

### 2. Discussion of Background Information

Large areas can be provided uniformly with thin films using a special LPPS process (“low pressure plasma spraying process”), that is an LPPS TF process (“LPPS thin film process”). This process, known for example from U.S. Pat. No. 5,853,815, is a plasma spraying process. The manufacture of a uniform coating is achieved by a spray gun having a geometrically suitable design. A substrate to be coated is put into a process chamber in which a pressure lower than 10 kPa is established, whereas a pressure of, for example, around 100 kPa (approximately ambient pressure) is present in the spray gun. The pressure drop between the interior of the spray gun and the process chamber has the effect that the thermal process beam expands to a broad beam in which the material to be sprayed is uniformly distributed: it is a thermal process beam which is generated by the plume of a defocusing plasma beam. A dense layer can be deposited over a relatively large area in a single passage by means of a process beam widened in this manner. Coatings having special properties can be generated by multiple deposition of such layers. Coating thicknesses in the micrometer range can be in particular be generated.

In a special LPPS TF process, a hybrid coating is carried out using the thermal process beam. This process, which is known from EP-A 1 034 843 (=P.7192) or from EP-A-1 479 788 (=P.7328), permits thermal spraying to be combined with a vapor phase deposition and so to unify the possibilities of both methods. The properties of the process beam are determined by controllable process parameters, in particular by the parameters of pressure, enthalpy, composition of a process gas mixture and composition and form of application of the material to be sprayed. A thermal barrier coating (TBC) with a columnar microstructure can be manufactured using the hybrid coating method. This coating or layer is approximately composed of cylindrical or spindle-like particles whose central axes are aligned perpendicular to the substrate surface. This columnar layer with an anisotropic microstructure is stretch tolerant with respect to a thermal strain variation, i.e. to changing strains, which result from repeatedly occurring temperature changes. The coating reacts to the changing strains in a largely reversible manner, i.e. without any formation of cracks, so that its service life is considerably extended in comparison with the service life of a coating which does not have a columnar microstructure.

The described plasma spraying method is a preferred coating method. Instead of a plasma beam, another thermal process beam could also be used to manufacture a coating having a columnar structure as well as a dense structure, if the coating material can be vaporized using such a thermal process beam. The invention described in the following includes this generalisation. Examples for further thermal process beams include but are not limited to: electron beams, flames of reactive gas mixtures, electrical arcs, laser beams.

### SUMMARY OF THE EMBODIMENTS

The invention provides a method for the manufacture of a coating having a columnar structure in which a necessary vaporization of coating material and deposition can be carried out more efficiently than in the known methods.

In the method for the manufacture of a coating (10) having a columnar structure, preferably a dense structure, a coating material in the form of primary corpuscles (1) is injected with a carrier gas into a thermal process beam. The coating material is transformed in the process beam into a vapor phase and is deposited as condensate in the form of a columnar coating on a substrate (100). The primary corpuscles are liquid droplets or they are in each case formed by an agglomerate of particles which are held together by cohesive forces of a connecting medium or by adhesive forces. The liquid droplets include a chemical precursor of the coating material in the form of a salt solution and are transformed by thermal action in the process beam into secondary corpuscles containing particles (2). The primary or secondary corpuscles are disintegrated in the process beam by mechanical and thermal interaction. In this connection, the particles are dispersed so that coating material is vaporised fully or partly by thermal action on the individual particles.

### BRIEF DESCRIPTION OF THE DRAWINGS

The invention will be explained in the following with reference to the drawings. There are shown:

FIG. 1 shows a section of a coating which was manufactured using the method in accordance with the invention;

FIG. 2 shows a schematic representation of an agglomerate which is a corpuscle composed of particles;

FIG. 3 shows an illustration for the disintegration of the agglomerate;

FIG. 4 shows a measured size distribution of the corpuscles of a spray powder in accordance with the invention;

FIG. 5 shows a segment of a turbine having two turbine vanes; and

FIG. 6 shows a section through the segment in FIG. 4 parallel to the base plate.

### DETAILED DESCRIPTION OF THE EMBODIMENTS

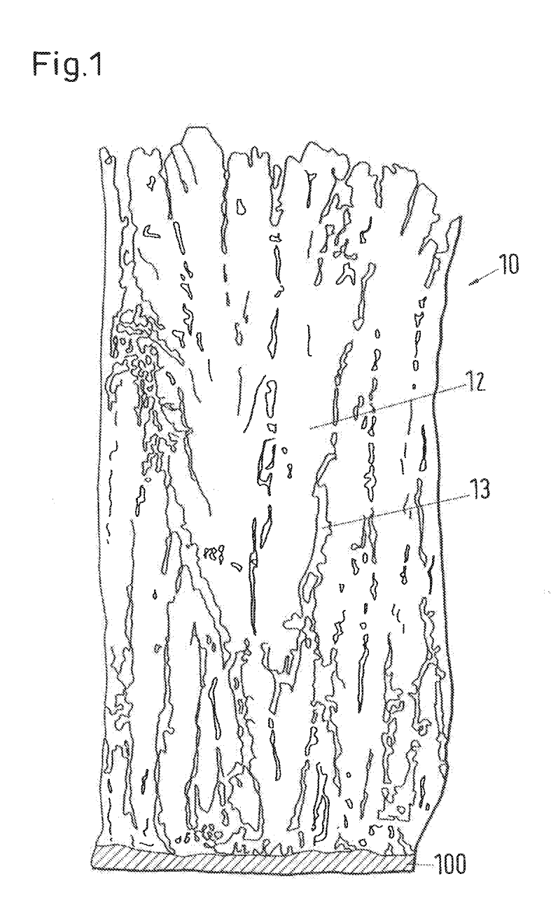

In the example of a coating 10 which is manufactured in accordance with the invention using a plasma spraying method and which is shown as a narrow section in FIG. 1, the coating 10 applied to a substrate 100 has a thickness of approximately one third of a millimeter. The section shown is drawn in the manner of a micrograph. Slit-like gaps 13, which are characteristic for a columnar structure, are disposed in the direction of the axes between elongate zones 12 whose axes are substantially perpendicular to the substrate 100. The coating material is in a state between the gaps 13 which is dense thanks to a low porosity. The porosity in relation to the total coating 10 is lower than 10 to 15%.

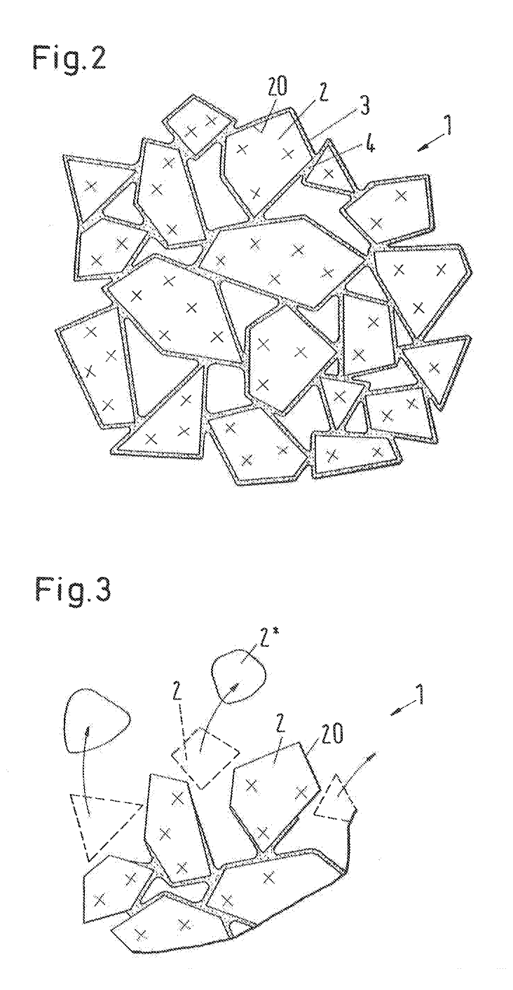

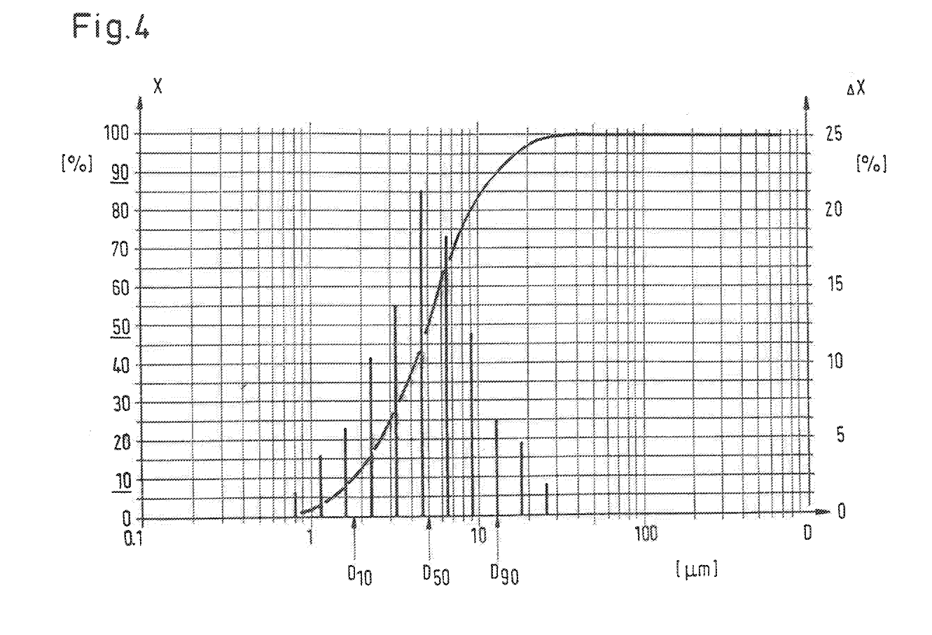

This coating 10 is generated with a spray powder which has the size distribution of corpuscles 1 documented in FIG. 4. The corpuscles 1 are composed of particles 2 to form an agglomerate such as is shown schematically in FIG. 2. The illustration shows a two-dimensional model of a corpuscle 1. The particles 2 drawn as polygons represent grains which have been generated, for example, from homogeneous solids by breaking and milling. The corpuscles 1 are each formed by an agglomerate of particles 2 which are held together by cohesive forces 4 of a connection medium 3 (binder). The medium 3 is present on the surfaces of the particles 2 as a thin film and as bridges communicating cohesive forces 4 between the particles 2.

In the plasma spraying process for the manufacture of the coating 10 having a columnar structure as well as a dense structure, the thermal process beam is generated by the plume of a defocusing plasma beam (cf. EP-A-1 034 843). A coating material in the form of the corpuscles 1 is injected with a carrier gas into the plasma beam. The properties of the plasma beam are determined by adjustable process parameters, in particular by the parameters of process pressure, enthalpy and composition of a process gas mixture. The method in accordance with the invention can also be carried out using other thermal process beams than the plasma beam. A further generalisation relates to the shape of the corpuscles 1. Primary corpuscles are distinguished from secondary ones:

The primary corpuscles 1 are formed by liquid droplets or in each case by an agglomerate of particles 2 which are held together by cohesive forces 4 of a connecting medium 3 (binder) or by adhesive forces. The adhesive forces are exerted directly between the particles without any binder, with a mechanical inter-engagement of surface structures (for example dendrites) being able to effect these forces. Binder-free connections between the particles 2 can also be generated by calcination at a low calcinating temperature and/or with a short treatment period. At this temperature or with this period, weak sintered connections are formed at contact points between the particles 2 which can also be understood as adhesive forces.

The droplet-like corpuscles 1 contain a chemical precursor of the coating material in the form of a salt solution and are transformed by thermal action in the process beam into the secondary corpuscles containing particles. Such a salt is, for example, zirconium nitrate which is transformed into zirconium oxide while splitting off nitric oxides.

The primary or secondary corpuscles are disintegrated in the process beam by mechanical and thermal interaction and the particles are dispersed so that coating material is melted and vaporized fully or partly by thermal action on the individual particles. A thermal decomposition or vaporization of the connecting medium 3 results from the thermal interaction. The disintegration of the corpuscles 1 is illustrated by FIG. 3. The medium 3 is thermally eliminated at the surfaces 20 of the peripheral particles 2 so that the particles 2 are separated by mechanical interaction and can be efficiently vaporized as dispersed particles 2* by the plume. The mechanical interaction results due to the viscosity of the plasma by shear forces between the plasma and the corpuscles 1.

The spray powder of the plasma spraying method is an aggregate of the primary corpuscles 1 which are formed in each case by an agglomerate of the particles 2. These primary corpuscles 1 can be generated by spraying of a slurry or slip. The slurry is made from the particles 2, from a liquid, a binder and, where necessary, a dispersing agent. The sprayed slurry is dried and the spray-dried material is used as a spray powder (with a post-treatment as a rule being necessary by further communition and sifting). The binder has been dissolved in the liquid of the slurry at a high dilution so that the cohesive forces 4 generated by the binder after the drying only effect a minimal holding together of the particles. The disintegration capability of the corpuscles 1 in the process beam can thereby be implemented.

Spray-dried spray powder can be manufactured as follows, for example. Powder-form coating material is slurried with a suitable liquid, preferably deionized water, and an organic binder to form a slurry. CMC (carboxy methyl cellulose) is a preferred binder. However, other known binders can also be used, for example PVA (polyvinyl alcohol) or MC (methyl cellulose). In a preferred embodiment of the slurry, the binder portion therein amounts to between approximately 0.5 and 5% by weight with respect to the dry weight of the coating material. The viscosity of the slurry influences the size of the spray-dried corpuscles so that this size can be varied simply by changing the liquid portion. The slurry is a suspension, which can be stabilized using a dispersing agent, for example using “Nopcosperse” (around 2% by weight).

The powder-form coating material can be gained by breaking of a material present in block form which is manufactured, for example, from a powder generated chemically and by precipitation and subsequently sintered. The powder gained in this manner consists of edged grains which are substantially more compact than the particles of the original powder. The compaction can be carried out in an induction oven or in an electrical arc.

The size distribution of the primary corpuscles 1 in the diagram of FIG. 4 can be represented by a bell curve. (X=cumulated volume portions; ΔX=differential volume portions). This curve can be characterized by three parameters, namely the maximum diameters Dᵢ (i=10, 50, 90) for the volume portions X10%, X50% and X90% which each include 10, 50 or 90% by volume of the primary corpuscles 1.

The following ranges apply to the diameters of a spray powder in accordance with the invention and to the corresponding volume portions:

for X10%: D₁₀<10 μm; for X50%: D₅₀<20 μm; for X90%: D₉₀<40 μm.
In FIG. 4, D₁₀=1. μm, D₅₀=4.94 μm and D₉₀=12.60 μm.

It is important for the invention that the primary corpuscles 1 are not too large. The corpuscles 1 may also not be too small so that the injecting into the process beam can take place without complications. The diameters should be less than 35 μm—corresponds to around—400 mesh. It might be advantageous if said diameter is larger than around 5 μm. The diameters for the particles 2 of the primary corpuscles 1 lie in the range between 0.1 and 5 μm. In the extreme case, a primary corpuscle 1 can comprise only one particle 2.

Three options are distinguished on how the coating material can be injected into the process beam: I) in the form of slurry droplets; II) in the form of droplets of the salt solution explained above; and III) as spray powder in the form of solid agglomerates. It in particular applies:

I) In the case of slurry droplets, capillary forces of a liquid form the cohesive forces. In this connection, this liquid, which as a rule contains a dispersing agent (but not a binder), has been used for the slurrying of the particles and for the generation of the slurry. The spraying of the slurry is carried out directly before the entry into the plasma beam.

II) The spraying of the salt solution is carried out directly before the entry into the process beam so that the particles of the secondary corpuscles are generated in the process beam.

III) If the coating material is used as a spray powder, the binder portion after the drying of the slurry droplets should amount to a maximum of 5% by weight and a minimum of 0.5% by weight. The binder portion preferably lies in the range between 1 and 2% by weight.

The following materials can be used, for example, for the slurry:

as the liquid, demineralized water or an organic solvent, in particular an alcohol;

as the dispersing agent, polycarbonic acid, a polycarboxylate compound or a polymetacarboxylate compound, polyethyleneimines or an amino alcohol;

and as the binder, polyvinyl alcohol, polyvinyl pyrolidine, polysaccharide, acrylic polymers and copolymers, starch, polyvinyl propylene, polyethylene glycols or a cellulose compound, for example carboxy methyl cellulose, methyl cellulose or hydroxyethylcellulose.

If the method in accordance with the invention is carried out as a plasma spraying process, this is done in accordance with the following specifications: a) a value is selected for the chamber process pressure between 50 and 5,000 Pa, preferably between 100 and 500 Pa. The specific enthalpy of the plasma beam is generated by delivering an effective power which is to be determined empirically and which lies, according to experience, in the range from 20 to 100 kW, preferably 40 to 80 kW.

b) The process gas includes a mixture of inert gases, in particular a mixture of argon Ar and helium He, and furthermore, optionally, hydrogen, nitrogen and/or a reactive gas, with the volume ratio of Ar to He advantageously lying in the range from 2:1 to 1:4 and the total gas flow lying in the range from 30 to 150 SLPM.

c) The primary corpuscles 1 are injected at a conveying rate between 5 and 60 g/min, preferably between 10 and 40 g/min.

d) The substrate is preferably moved relative to a cloud of the vaporised coating material during the material application, in particular by rotary or pivot movements and/or by translatory movements.

A coating material is used whose portion which can be vaporized amounts to at least 70%. The plasma beam is generated with a sufficiently high specific enthalpy so that at least 5% of the coating material, preferably at least 50%, is transformed into the vapor phase during vaporisation.

The particles 2 form a homogeneous or heterogeneous mixture with materials which are the same or different in the primary corpuscles 1.

The particles 2 can form a mixture of materials which react chemically in the process beam after the vaporisation at least partly with one another or with a reactive gas of the process gas mixture. The reaction products are condensed out during coating.

In the manufacture of a TBC coating having a columnar structure, an advantageous connection of the coating to the substrate arises onto which the columnar coating is applied. Whereas a large-area peeling of the coatings caused by thermal strain variation is observed with non-columnar coatings, the same thermal strain variation results in milder damage with the columnar coating: A dandruff like precipitation of relatively small-area coating islands is created.

In a preferred process management, regions of the substrate 100 are coated which are located in the geometrical shadow of the process beam.

Thermal spray processes are usually so-called “line-of-sight processes”, that is the substrate 100 is only coated where the thermal process beam impacts directly. Regions which are located in the geometrical shadow, that is are not directly exposed to the process beam, are not coated in such processes.

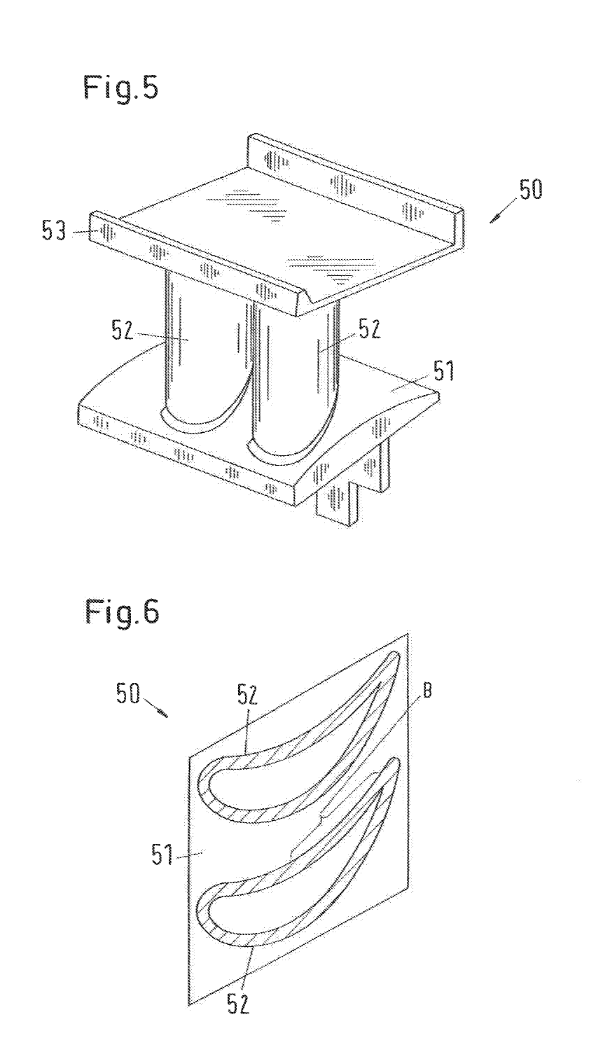

It is, however, also possible with the method in accordance with the invention to coat regions of the substrate 100 which are not directly exposed—in the geometrical sense—to the process beam. That is, “non-line-of-sight” coating can also be carried out with the method in accordance with the invention. Coating can take place so-to-say around the corner. This should be explained in the following with respect to FIG. 5 and to FIG. 6.

FIG. 5 shows, in a very simplified representation, a segment of a turbine which is designated in total by the reference numeral 50. FIG. 6 shows this segment 50 in a sectional presentation, with the cut taking place parallel to a base plate designated by 51 in FIG. 5.

The turbine, for example, a gas turbine, usually includes a plurality of rotating impellers and stationary guide elements. Both the impellers and the guide elements each include a plurality of turbine vanes 52. The turbine vanes 52 can each be mounted individually at their foot to a common axle of the turbine or they can be provided in the form of segments which each include a plurality of turbine vanes 52. This configuration is frequently called a cluster-vane segment or, depending on the number of turbine vanes, a double-vane segment, a triple-vane segment, etc.

In FIG. 5 and in FIG. 6, there is shown in a very simplified representation such a segment 50 of a gas turbine which includes two turbine vanes 52 which each extend from the base plate 51 up to a cover plate 53. The segment 50 can be in one piece or consist of a plurality of individual parts. The presentation of details known per se such as cooling air bores or cooling air passages has been omitted in FIGS. 5 and 6 for reasons of better clarity.

In such substrates 100 such as the segment 50, geometrical shadow regions, hidden regions, or otherwise covered regions exist which cannot be acted on directly—in the geometrical sense—by the process beam. Such regions are designated by the reference symbol B in FIG. 6. It is frequently the case that such regions B can also not be reached due to a rotation of the substrate 100 in the process beam or due to another relative movement between the process beam and the substrate.

A coating can also be manufactured using the method in accordance with the invention in such regions B which are located in the geometrical shadow of the process beam, that is not in the line-of-sight of the process beam. It is consequently possible with the method in accordance with the invention to coat around corners, edges and rounded portions.

This is in particular advantageous for the coating of turbine vanes of gas turbines and specifically for segments of such turbines which include two or more turbine vanes.

In addition, the method in accordance with the invention also allows to coat regions of the substrate 100 that are at a low incidence angle of less than 45 degrees relative to the process beam. Most thermal spray processes operate at a perpendicular incidence angle in order for the particles to deposit. Reducing this angle usually reduces effectiveness in achieving a desirable coating (both in thickness and structure). The benefit of the method according to the invention is it can deposit at low incidence angles and/or non-line-of-sight.

What is claimed:

1. A method for the manufacture of a coating (10) having a columnar structure, preferably a dense structure, in which method a coating material in the form of primary corpuscles (1) is injected with a carrier gas into a thermal process beam, the coating material is transferred into a vapor phase in the process beam and is deposited as a condensate in the form of a columnar coating on a substrate (100) and the primary corpuscles are formed by an agglomerate of particles (2) which are held together by cohesive forces of a connecting medium (3) or by adhesive forces,
characterized in that the primary corpuscles are disintegrated in the process beam by mechanical and thermal interaction and the particles are dispersed so that coating material is vaporized fully or partly by thermal action on the individual particles.

2. A method in accordance with claim 1, characterized in that the primary corpuscles (1) are generated by spraying of a slurry, and in that two cases can be distinguished:
I) the spraying of the slurry is carried out directly before the entry into the process beam, with capillary forces of a liquid forming the cohesive forces and this liquid, which as a rule contains a dispersing agent, having been used for a slurrying of the particles and for the generation of the slurry; or
II) the slurry is manufactured from the particles (2) from a liquid, from a binder, and, optionally, from the dispersing agent, the sprayed slurry is subsequently dried and the spray-dried material is used as a spray powder, with the binder having been dissolved in the liquid of the slurry at a high dilution so that the cohesive forces generated by the binder after the drying only effect a minimal holding together of the particles.

3. A method in accordance with claim 2, characterized in that the binder portion after the drying amounts to 0.5 to 5% by weight, preferably to 1-2% by weight, on the use of the spray powder; and
in that the following materials are used, for example, for the slurry:
as the liquid, demineralized water or an organic solvent, in particular an alcohol;
as the dispersing agent, polycarbonic acid, a polycarboxylate compound or a polymetacarboxylate compound, polyethyleneimines or an amino alcohol;
and as the binder, polyvinyl alcohol, polyvinylpyrrolidine, polysaccharide, acrylic polymers and copolymers, starch, polyvinyl propylene, polyethylene glycols or a cellulose compound, for example carboxy methyl cellulose, methyl cellulose or hydroxyethylcellulose.

4. A method in accordance with claim 1, characterized in that the thermal process beam is generated by a plume of a defocusing plasma beam, with the properties of the process beam being determined by adjustable process parameters, in particular by the parameters of process pressure, enthalpy and composition of a process gas mixture.

5. A method in accordance with claim 4, characterized in that
a) a value is selected for the process pressure between 50 and 2,000 Pa, preferably between 100 and 500 Pa and the specific enthalpy of the plasma beam is generated by delivering an effective power which is to be determined empirically and which lies, according to experience, in a range from 20 to 100 kW, preferably 40 to 80 kW;
b) the process gas includes a mixture of insert gases, in particular a mixture of argon Ar and helium He, and furthermore, optionally, hydrogen, nitrogen and/or a reactive gas, with the volume ratio of Ar to He advantageously lying in the range from 2:1 to 1:4 and the total gas flow lying in the range from 30 to 150 SLPM;
c) the primary corpuscles are injected at a conveying rate between 5 and 60 g/min, preferably between 10 and 40 g/min; and
d) the substrate is preferably moved relative to a cloud of the vaporized material during the material application, in particular by rotary or pivot movements and/or by movements in translation.

6. A method in accordance with claim 1, characterized in that a coating material is used whose portion which can be vaporized amounts to at least 70%; and in that a plasma beam with sufficiently high specific enthalpy is generated or that at least 5% of the coating material, preferably at least 50%, is transferred into the vapor phase during vaporization.

7. A method in accordance with claim 1, characterized in that regions (B) of the substrate (200) are coated which are located in the geometrical shadow of the process beam.

8. A method in accordance with claim 1, wherein the substrate is a turbine vane (52) or a segment (50) having at least two turbine vanes (52).

9. A method in accordance with claim 1, wherein the powder is an aggregate of corpuscles which are formed in each case by an agglomerate of particles; and in that the particles are connected by cohesive forces of a binder, in particular of a binder, or by adhesive forces, with the binder portion amounting to 0.5-5% by weight, preferably 1-2% by weight; wherein the diameters lie in the range between 0.1 and 5 μm for the particles of the primary corpuscles; and wherein the diameters of the primary corpuscles are smaller than 35 μm and larger than 5 μm.

10. A method in accordance with claim 9, characterized in that oxide ceramic materials are used as the coating materials; in that the materials are oxides of Zr, Al, Ti, Cr, Ca, Mg, Si, Ti, Y, La, Ce, Sc, Pr, Dy, Gd, Sm, Mn, Sr or combination of these chemical elements.

11. A method in accordance with claim 9, characterized in that a material suitable for a thermal barrier coating TBC is used as the coating material, in particular one of the following oxides or a combination of these oxides:zirconium oxide ZrO₂, yttrium oxide Y₂O₃, ytterbium oxide Yb₂O₅, dysprosium oxide Dy₂O₃, gadolinium oxide Gd₂O₃, cerium oxide CeO₂, magnesium oxide MgO, calcium oxide CaO, europium oxide Eu₂O₃, erbium oxide Er₂O₃ scandium oxide Sc₂O₃, lanthanide oxides and actinide oxides, with these materials being able to be present in a fully stabilized or partly stabilized form and with the following stabilizers and concentration ranges being provided with a TBC of ZrO₂:
a) Y₂O₃—4-20% by weight, preferably 6-9% by weight;
b) Yb₂O₅—4-20% by weight, preferably 10-16% by weight;
c) Y₂O₃ and Yb₂O₅—4-20% by weight, preferably 4-16% by weight;
d) Y₂O₃ and Yb₂O₅ and Sc₂O₃ or lanthanide oxides—4-20% by weight, preferably 4-16% by weight.

12. A method in accordance with claim 9, characterized in that the particles in the corpuscles form a homogeneous or heterogeneous mixture with materials which are the same or different.

13. A method in accordance with claim 9, characterized in that the particles in the corpuscles form a mixture of materials which react chemically in the process beam after the vaporization at least partly with one another or with a reactive gas of the process gas mixture and are condensed out as reaction products during the coating.
